(19) United States
(12) Patent Application Publication
(10) Pub. No.: US 2026/0145548 A1
(43) Pub. Date: May 28, 2026

(54) BATTERY ELECTRIC VEHICLE

(71) Applicant: TOYOTA JIDOSHA KABUSHIKI KAISHA, Toyota-shi (JP)

(72) Inventor: Shinya Shiratori, Susono-shi (JP)

(73) Assignee: TOYOTA JIDOSHA KABUSHIKI KAISHA, Toyota-shi (JP)

(21) Appl. No.: 19/276,594

(22) Filed: Jul. 22, 2025

(30) Foreign Application Priority Data
Nov. 27, 2024 (JP) 2024-206436

(51) Int. Cl. B60L 15/20

(52) U.S. Cl. CPC B60L 15/2045

(57) ABSTRACT

A battery electric vehicle includes one or more processors configured to control an output of the electric motor. When the battery electric vehicle is in a proficiency mode, the one or more processors acquire information on a target virtual vehicle selected from among a plurality of virtual vehicles. In addition, the one or more processors control the output of the electric motor such that an acceleration characteristic of the battery electric vehicle with respect to a driving operation of a driver becomes a simulated acceleration characteristic of the target virtual vehicle at the time of initiation of the proficiency mode, and control the output of the electric motor such that the acceleration characteristic of the battery electric vehicle with respect to the driving operation of the driver is close to a standard acceleration characteristic as proficiency of the driver increases.

### CROSS-REFERENCE TO RELATED APPLICATION

This application claims priority to Japanese Patent Application No. 2024-206436 filed on Nov. 27, 2024. The disclosure of the above-identified application, including the specification, drawings, and claims, is incorporated by reference herein in its entirety.

### BACKGROUND

### 1. Technical Field

The present disclosure relates to a battery electric vehicle including an electric motor as a drive source.

### 2. Description of Related Art

An electric motor can be controlled to output a desired motor torque by controlling a voltage or a magnetic field to be applied. By using this, a technique for reproducing various driving environments in a battery electric vehicle by appropriately controlling an electric motor of the battery electric vehicle has been considered. For example, Japanese Patent No. 7529003 (JP 7529003 B) discloses a battery electric vehicle that can simulate a driving sensation of a clutch pedalless manual transmission vehicle including a sequential shifter.

### SUMMARY

A case where a user newly changes to the battery electric vehicle is considered. In this case, the acceleration characteristic of a vehicle previously driven by the user and that of the battery electric vehicle may differ significantly. In such a case, it is difficult for the user (driver) to immediately adapt to a standard acceleration characteristic of the battery electric vehicle. As a result, the user (driver) may feel tired or may be careless about safe driving.

In addition, the above method may be used to drive the battery electric vehicle such that acceleration characteristics of various virtual vehicles are reproduced. Meanwhile, the battery electric vehicle can naturally also be driven with the standard acceleration characteristic. Therefore, it is considered that the user (driver) drives a battery electric vehicle driven to reproduce the acceleration characteristic of a certain virtual vehicle, and then attempts to drive a battery electric vehicle driven with the standard acceleration characteristic. In this case, the reproduced acceleration characteristic and the standard acceleration characteristic may differ significantly. In such a case also, the driver has difficulty in immediately adapting to the standard acceleration characteristic of the battery electric vehicle.

The present disclosure can provide a technique for assisting a driver in becoming accustomed to a standard acceleration characteristic of a battery electric vehicle.

An aspect of the present disclosure relates to a battery electric vehicle including an electric motor as a drive source. The battery electric vehicle includes one or more processors control an output of the electric motor.

The one or more processors, when the battery electric vehicle is in a proficiency mode, acquire information on a target virtual vehicle selected from among a plurality of virtual vehicles.

In addition, the one or more processors control the output of the electric motor such that an acceleration characteristic of the battery electric vehicle with respect to a driving operation of a driver becomes a simulated acceleration characteristic of the target virtual vehicle when the proficiency mode is initiated, and control the output of the electric motor such that the acceleration characteristic of the battery electric vehicle with respect to the driving operation of the driver is close to a standard acceleration characteristic, as proficiency of the driver increases.

According to the present disclosure, when the battery electric vehicle is in the proficiency mode, the acceleration characteristic of the battery electric vehicle with respect to the driving operation of the driver changes from the simulated acceleration characteristic of the target virtual vehicle to the standard acceleration characteristic in accordance with the proficiency of the driver. As a result, in the proficiency mode, the driver can gradually become accustomed to the standard acceleration characteristic of the battery electric vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a configuration of a battery electric vehicle according to an embodiment;

FIG. 2 is a diagram showing an example of standard acceleration characteristics of a battery electric vehicle and simulated acceleration characteristics of a target virtual vehicle;

FIG. 3 is a tree diagram showing an example of a selection input that is received by an HMI regarding a control mode of a battery electric vehicle according to the embodiment;

FIG. 4 is a diagram showing an example of a functional configuration of a control device that functions as a drive control device;

FIG. 5 is a diagram showing an example of a functional configuration of the second target drive force calculation unit;

FIG. 6 is a flowchart showing a processing flow of proficiency determination processing related to one of the conditions that decrease the proficiency;

FIG. 7 is a flowchart showing a processing flow of the proficiency mode calculation processing;

FIG. 8 is a diagram showing an example of the configuration of the vehicle model; and

FIG. 9 is a diagram showing an example of a functional configuration of a control device that functions as an in-vehicle apparatus control device.

### DETAILED DESCRIPTION OF EMBODIMENTS

Hereinafter, embodiments of the present disclosure will be described with reference to drawings. In each figure, the same reference numeral is assigned to the same or corresponding part and a description thereof is simplified or omitted.

### 1. Configuration of Power System of Battery Electric Vehicle

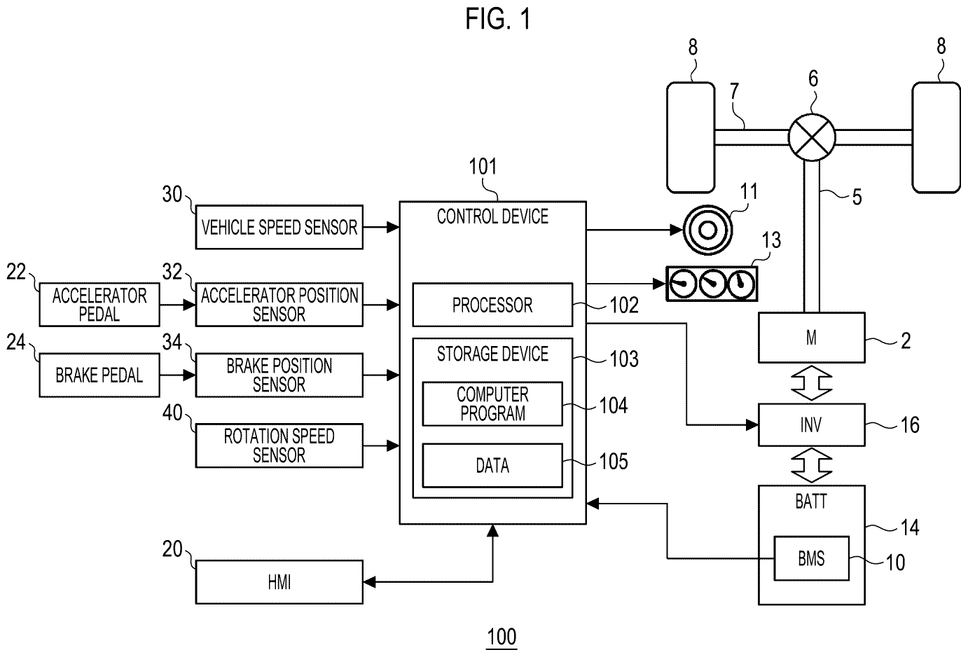

FIG. 1 is a diagram schematically showing a configuration of a battery electric vehicle 100 according to an embodiment of the present disclosure. First, a configuration of a power system of a battery electric vehicle 100 will be described with reference to FIG. 1.

The battery electric vehicle 100 includes an electric motor (M) 2 as a drive source for traveling. The electric motor 2 is, for example, a three-phase alternating current motor. An inverter (INV) 16 is attached to the electric motor 2. An output shaft of the electric motor 2 is connected to the propeller shaft 5 via a speed reducer (not shown). The propeller shaft 5 is connected to a differential gear 6. The differential gear 6 is connected to left and right drive wheels 8 by left and right drive shafts 7. The drive wheels may be front wheels or rear wheels.

The inverter 16, the electric motor 2, the speed reducer, and the differential gear 6 may be integrally configured as an e-axle. In this case, the battery electric vehicle 100 does not include the propeller shaft 5, and the e-axle is connected to the drive shaft 7.

In addition, as still another Modification, the configuration of the battery electric vehicle 100 may be four-wheel drive. For example, the battery electric vehicle 100 may include a transfer connected to the electric motor 2 and be configured to distribute the output of the electric motor 2 to the front wheels and the rear wheels by the transfer. In addition, for example, the battery electric vehicle 100 may be configured to include an e-axle in each of a front drive shaft 7 and a rear drive shaft 7.

The inverter 16 is connected to a battery (BATT) 14. The inverter 16 is, for example, a voltage type inverter, and controls a motor torque of the electric motor 2 by PWM control. That is, the battery electric vehicle 100 is a battery electric vehicle (BEV) that travels by electric energy stored in the battery 14 with the electric motor 2 as a drive source.

### 2. Configuration of Control System of Battery Electric Vehicle

Subsequently, the configuration of the control system of the battery electric vehicle 100 will be described with reference to FIG. 1.

The battery electric vehicle 100 includes a vehicle speed sensor 30. The vehicle speed sensor 30 outputs a signal indicating the vehicle speed of the battery electric vehicle 100. At least one of wheel speed sensors (not shown) provided on each of left and right front wheels and left and right rear wheels is used as the vehicle speed sensor 30.

The battery electric vehicle 100 includes an accelerator position sensor 32. The accelerator position sensor 32 is provided in the accelerator pedal 22 and outputs a signal indicating an operation state of the accelerator pedal 22. The operation state of the accelerator pedal 22 typically includes an accelerator operation amount and an accelerator operation speed. The battery electric vehicle 100 may be provided with a lever-type or dial-type accelerator operation device that is operated by hand instead of the accelerator pedal 22. Also in this case, the accelerator position sensor 32 outputs a signal indicating the operation state of these accelerator operation devices.

The battery electric vehicle 100 includes a brake position sensor 34. The brake position sensor 34 is provided on the brake pedal 24 and outputs a signal indicating an operation state of the brake pedal 24. The operation state of the brake pedal 24 typically includes a brake operation amount or a brake operation speed.

The accelerator pedal 22 and the brake pedal 24 are each one of driving operation members used for driving the battery electric vehicle 100. In addition, the battery electric vehicle 100 may include various driving operation members, such as a steering wheel for driving related to steering.

The battery electric vehicle 100 includes a rotation speed sensor 40. The rotation speed sensor 40 is provided in the electric motor 2, and outputs a signal indicating a rotation speed of the electric motor 2.

The battery electric vehicle 100 includes a battery management system (BMS) 10. The battery management system 10 is a device that monitors a cell voltage, current, temperature, and the like of the battery 14. In particular, the battery management system 10 has a function of estimating a state of charge (SOC) of the battery 14.

The battery electric vehicle 100 includes a human machine interface (HMI) 20. The HMI 20 presents various types of information to the driver by display or sound, and also receives various types of inputs from the driver. The HMI 20 is composed of a display, a touch screen, a switch, a touch pad, a speaker phone, a microphone, and the like. The display is, for example, a multi-information display, a meter display, or a multimedia display. The switch is, for example, a steering switch, a multimedia switch, or a door switch. Further, the HMI 20 may include a user terminal (for example, a smartphone or a tablet) connected to the battery electric vehicle 100. For example, the HMI 20 displays various pieces of information on the display and receives an input from the driver for the display content by a touch operation on the touch screen.

The battery electric vehicle 100 includes a speaker 11. The speaker 11 includes a vehicle interior speaker that generates sound at least in the vehicle cabin of the battery electric vehicle 100. As another example, the speaker 11 may include a vehicle exterior speaker that generates sound outside the battery electric vehicle 100. The battery electric vehicle 100 may include both a vehicle interior speaker and a vehicle exterior speaker as the speaker 11. The speaker 11 may be configured as a part of the HMI 20. The output of the speaker 11 is controlled by a control device 101 described below.

The battery electric vehicle 100 includes an instrument 13. The instrument 13 displays various kinds of information. Examples of the instrument 13 include a speedometer, an odometer, a tachometer, a trip meter, and a battery charge meter. The instrument 13 may be configured as a part of the HMI 20. The display of the instrument 13 is controlled by a control device 101 described below.

The battery electric vehicle 100 includes a control device 101. Various sensors and control target devices mounted on the battery electric vehicle 100 are connected to the control device 101 by an in-vehicle network, such as a control area network (CAN). Various sensors may be mounted on the battery electric vehicle 100 and connected to the control device 101 via an in-vehicle network. Various sensors are, for example, a vehicle speed sensor 30, an accelerator position sensor 32, a brake position sensor 34, and a rotation speed sensor 40.

The control device 101 generates a control signal for various controls of the battery electric vehicle 100 based on signals acquired from the respective sensors. The control device 101 is typically an electronic control unit (ECU). The control device 101 may be a combination of a plurality of ECUs. The control device 101 includes one or a plurality of processors 102 (hereinafter, simply referred to as processor 102) and one or a plurality of storage devices 103 (hereinafter, simply referred to as storage device 103).

The processor 102 executes various types of processing. The processor 102 is configured of, for example, a general-purpose processor, a specific-purpose processor, a central processing unit (CPU), a graphics processing unit (GPU), an application specific integrated circuit (ASIC), a field-programmable gate array (FPGA), an integrated circuit, a conventional circuit, and a combination of one or a plurality of these. The processor 102 can also be referred to as processing circuitry. The processing circuitry is hardware programmed to realize the function of the control device 101, or hardware that executes the function of the control device 101.

The storage device 103 stores various types of information needed to execute the processing of the processor 102. The storage device 103 is configured of a recording medium, such as a random access memory (RAM), a read only memory (ROM), a solid state drive (SSD), or a hard disk drive (HDD). The storage device 103 stores a computer program 104 that can be executed by the processor 102 and various data 105. The computer program 104 is composed of a plurality of instruction codes that describe processing to be executed by the processor 102. The computer program 104 is recorded on a computer-readable recording medium. The processor 102 that executes the computer program 104 and the storage device 103 cooperate with each other to realize the function of the control device 101.

The control device 101 according to the present embodiment has at least two control modes, a normal mode and a proficiency mode, for the control of the battery electric vehicle 100. The control of the battery electric vehicle 100 to be executed by the control device 101 is changed according to the selected control mode. Hereinafter, a control mode of the battery electric vehicle 100 will be described.

### 3. Control Mode of Battery Electric Vehicle

As described above, there are at least two control modes for the battery electric vehicle 100: a normal mode and a proficiency mode. The normal mode is a control mode in which control is performed such that the battery electric vehicle 100 is driven as a normal BEV. Hereinafter, the acceleration characteristic of the battery electric vehicle 100 in the normal mode is referred to as “standard acceleration characteristic”. The proficiency mode is a control mode for assisting the user (driver) in becoming accustomed to driving in the normal mode in a case where the user has newly changed to the battery electric vehicle 100, for example.

In a case where the user has newly changed to the battery electric vehicle 100, the acceleration characteristics of the vehicle in which the user has previously been on board and that of the battery electric vehicle 100 may be significantly different. In such a case, the user (driver) has difficulty in immediately adapting to driving with the standard acceleration characteristic. As a result, the user (driver) feels tired or is careless about safe driving. The proficiency mode is provided to address such a case and to assist the driver in becoming accustomed to driving with the standard acceleration characteristic. Specifically, the control mode may be the proficiency mode. At the initiation time of that time, the battery electric vehicle 100 is controlled to be driven based on the acceleration characteristic (hereinafter, referred to as “simulated acceleration characteristic”) of the virtual vehicle (hereinafter, referred to as “target virtual vehicle”) selected from among the plurality of virtual vehicles. In this case, the driver can set, for example, a vehicle that the driver has previously boarded as the target virtual vehicle. As a result, the driver can drive the battery electric vehicle 100 with the simulated acceleration characteristic of the vehicle that the driver has previously boarded immediately after the initiation of the proficiency mode. In the proficiency mode, the proficiency of the driver is determined, and the battery electric vehicle 100 is controlled to be driven with the acceleration characteristic close to the standard acceleration characteristic as the proficiency increases. That is, the more proficiency increases, the more the driver drives the battery electric vehicle 100 with the acceleration characteristic closer to the standard acceleration characteristic. Finally, the driver will drive the battery electric vehicle 100 with the standard acceleration characteristic.

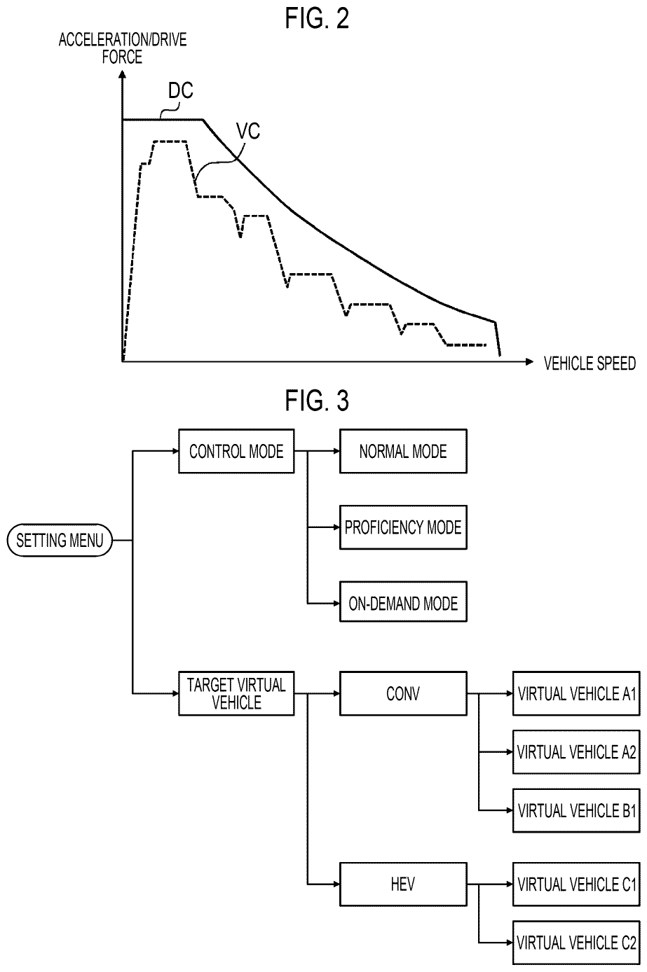

FIG. 2 is a diagram showing an example of a standard acceleration characteristic DC of the battery electric vehicle 100 and a simulated acceleration characteristic VC of the target virtual vehicle. In the proficiency mode, the acceleration characteristic of the battery electric vehicle 100 gradually changes from the simulated acceleration characteristic VC to the standard acceleration characteristic DC according to the proficiency of the driver. In this way, the proficiency mode assists the driver in becoming accustomed to driving in the normal mode.

The control mode of the battery electric vehicle 100 may further include an “on-demand mode” in which the driving environment characteristic of the target virtual vehicle is reproduced in the battery electric vehicle 100. When the control mode is the on-demand mode, the control is performed such that the battery electric vehicle 100 is driven by the simulated acceleration characteristic VC of the target virtual vehicle. In the on-demand mode, unlike the proficiency mode, the acceleration characteristic does not gradually change. That is, the driver can experience the driving environment as if driving the target virtual vehicle.

By the way, after the driver has driven the battery electric vehicle 100 in the on-demand mode for a while, the driver may try to switch to the normal mode and drive the battery electric vehicle 100. In this case, the standard acceleration characteristic DC and the simulated acceleration characteristic VC of the target virtual vehicle may be significantly different. Even in such a case, the driver has difficulty in immediately adapting to the driving at the standard acceleration characteristic. The proficiency mode can also be used to address such a problem related to the on-demand mode. That is, by switching from the on-demand mode to the proficiency mode, the acceleration characteristic of the battery electric vehicle 100 gradually changes from the simulated acceleration characteristic VC to the standard acceleration characteristic DC according to the proficiency of the driver. As a result, the driver can gradually become accustomed to driving in the normal mode.

Each of the virtual vehicles is typically a vehicle with an acceleration characteristic different from the standard acceleration characteristic DC of the battery electric vehicle 100. In particular, in the on-demand mode, the virtual vehicle may be various forms of vehicles, such as a motorcycle or a train. In addition, each of the virtual vehicles may be assumed to be a real vehicle, or may be assumed to be a vehicle that is not present in reality. The difference in the acceleration characteristic is generally due to a difference in a configuration of a powertrain from the drive source to the drive wheels or a difference in a control method of the powertrain. Therefore, the plurality of virtual vehicles may be considered to include various vehicles in which at least some elements of the configuration or the control method related to the powertrain are different.

The driver operates the HMI 20 to select the control mode. The HMI 20 is configured to receive a selection input of the control mode from the driver. Further, the HMI 20 is configured to receive a selection input of the target virtual vehicle from the driver.

FIG. 3 is a tree diagram showing an example of the selection input received by the HMI 20. For example, the HMI 20 receives the selection input from the driver as follows in accordance with the tree shown in FIG. 3 via the display, the touch screen, or the display of the user terminal.

First, the HMI 20 displays a setting menu screen on a display, a touch screen, or a user terminal in response to an operation of the driver. An initial screen of the setting menu screen displays an option “control mode” and an option “target virtual vehicle”. The option “control mode” is to receive the selection input of the control mode from the driver. The option “target virtual vehicle” is to receive the selection input of the target virtual vehicle from the driver.

When the option “control mode” is selected, next, the options “normal mode”, “proficiency mode”, and “on-demand mode” are displayed on the setting menu screen. When the option “normal mode” is selected, the HMI 20 determines that the control mode of the battery electric vehicle 100 is the normal mode. When the option “proficiency mode” is selected, the HMI 20 determines that the control mode of the battery electric vehicle 100 is the proficiency mode. When the option “on-demand mode” is selected, the HMI 20 determines that the control mode of the battery electric vehicle 100 is the on-demand mode. In this manner, the HMI 20 receives the selection input of the control mode from the driver.

On the other hand, when the option “target virtual vehicle” is selected, the options “CONV” and “HEV” are displayed on the setting menu screen. The option “CONV” and the option “HEV” respectively indicate classifications of the plurality of virtual vehicles that are selectable in the on-demand mode. CONV is a classification indicating an engine vehicle equipped with a conventional internal combustion engine (conventional vehicle). The HEV is a classification indicating a hybrid electric vehicle (hybrid electronic vehicle). When the option “CONV” is selected, next, the setting menu screen displays an option “virtual vehicle A1”, an option “virtual vehicle A2”, and an option “virtual vehicle B1”. The virtual vehicle A1, the virtual vehicle A2, and the virtual vehicle B1 are the virtual vehicles classified into the CONV among the plurality of selectable virtual vehicles. Similarly, when the option “HEV” is selected, next, the setting menu screen displays an option “virtual vehicle C1” and an option “virtual vehicle C2”. The virtual vehicle C1 and the virtual vehicle C2 are the virtual vehicles classified into the HEV among the plurality of selectable virtual vehicles. In a case where any one of the options is selected, the HMI 20 determines that the selected virtual vehicle is the target virtual vehicle. For example, when the option “virtual vehicle A2” is selected, the HMI 20 determines that the virtual vehicle A2 is the target virtual vehicle. In this manner, the HMI 20 receives the selection input of the target virtual vehicle from the driver.

The classification of the plurality of virtual vehicles in the above description is an example, and the option related to the classification may be changed as appropriate. For example, the options related to the classification may further include options indicating a plug-in hybrid electric vehicle (PHEV) or a fuel cell electric vehicle (FCEV). In addition, for example, the options related to the classification may indicate other classifications, such as a classification related to the type of the mounted drive source (for example, an in-line four-cylinder turbocharged engine, a flat six-cylinder engine, a V12 engine, a battery, and a fuel cell). In addition, for example, the options related to the classification may be configured in a plurality of hierarchies. For example, after the option “CONV” is selected, the setting menu screen may further display an option related to classification of the type of the drive source. Alternatively, when the option “target virtual vehicle” is selected, the setting menu screen may display the options related to the virtual vehicle in a list without displaying the options related to the classification.

In addition, the name displayed on the setting menu screen for each of the options may be appropriately given in consideration of the ease of understanding of the driver. For example, in the option related to the virtual vehicle, the displayed name may be a specific name, such as a vehicle model or a product name, that allows the driver to easily imagine the virtual vehicle.

As described above, the driver can select the control mode by operating the HMI 20. The control device 101 controls the battery electric vehicle 100 in response to the selected control mode.

The control device 101 according to the present embodiment functions as a drive control device that performs drive control of the battery electric vehicle 100 by controlling the output of the electric motor 2 in response to a driving operation of the driver. Specifically, the control device 101 functions as a drive control device by the processor 102 executing the computer program 104 for drive control stored in the storage device 103. Hereinafter, the control of the battery electric vehicle 100 by the drive control device will be described.

### 4. Drive Control Device

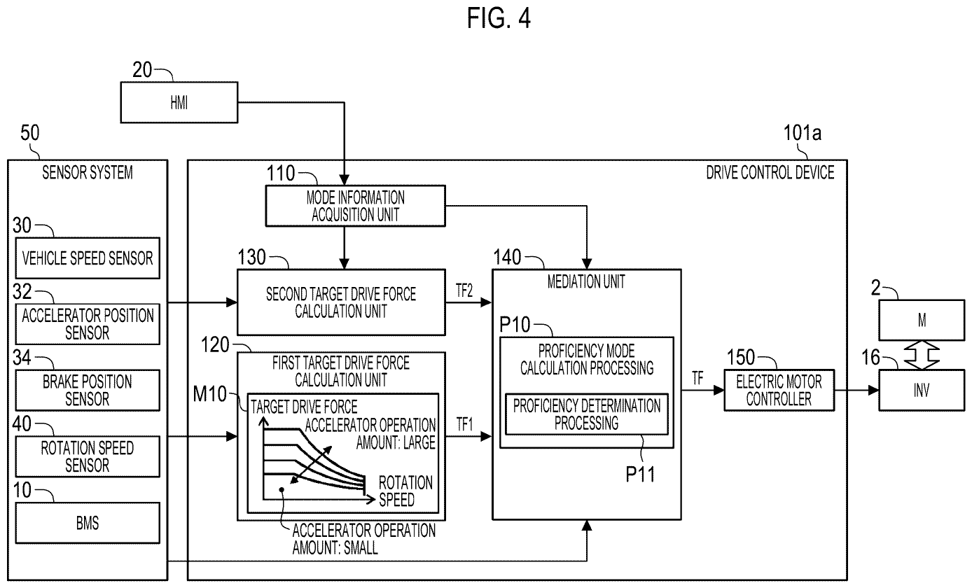

FIG. 4 is a diagram showing an example of a functional configuration of the drive control device 101a. The drive control device 101a calculates a target drive force TF of the battery electric vehicle 100 in response to the driving operation of the driver. The drive control device 101a controls the output of the electric motor 2 such that the calculated target drive force TF is realized.

The drive control device 101a receives signals from the HMI 20 and the sensor system 50. The sensor system 50 includes a vehicle speed sensor 30, an accelerator position sensor 32, a brake position sensor 34, a rotation speed sensor 40, and the battery management system 10. The sensor system 50 may further include a steering angle sensor for detecting a steering angle of the steering wheel and a yaw rate sensor for detecting a yaw rate of the battery electric vehicle 100. The sensor system 50 may further include an inertial measurement unit (IMU) for detecting the posture of the battery electric vehicle 100, a sensor (for example, a camera, a radar, or LiDAR) for detecting the surrounding environment of the battery electric vehicle 100, and the like.

The signals input to the drive control device 101a from the HMI 20 include a signal indicating the selected control mode and a signal indicating the selected target virtual vehicle. The signals input to the drive control device 101a from the sensor system 50 include a signal indicating the vehicle speed of the battery electric vehicle 100, a signal indicating the operation state of the accelerator pedal 22, and a signal indicating the operation state of the brake pedal 24. The signals input to the drive control device 101a from the sensor system 50 further include a signal indicating the rotation speed of the electric motor 2 and a signal indicating the state of charge (SOC) of the battery 14.

The drive control device 101a includes, as functional blocks, a mode information acquisition unit 110, a first target drive force calculation unit 120, a second target drive force calculation unit 130, a mediation unit 140, and an electric motor controller 150. These functional blocks are realized by the cooperation of the processor 102 that executes the computer program 104 and the storage device 103.

The mode information acquisition unit 110 receives a signal from the HMI 20 and acquires information on which of the normal mode, the proficiency mode, and the on-demand mode is selected. In addition, the mode information acquisition unit 110 acquires information on the target virtual vehicle selected from among the plurality of virtual vehicles. The mode information acquisition unit 110 transmits the information on the selected control mode to the mediation unit 140. In addition, the mode information acquisition unit 110 transmits the information on the selected target virtual vehicle to the second target drive force calculation unit 130.

The first target drive force calculation unit 120 calculates a first target drive force TF1 that is a target drive force for realizing the standard acceleration characteristic DC, based on a signal from the sensor system 50. The first target drive force TF1 can also be the target drive force for driving the battery electric vehicle 100 in the normal mode.

The first target drive force calculation unit 120 calculates the first target drive force TF1 by using a map M10. The map M10 provides the first target drive force TF1 with the operation state of the driving operation member and the traveling state of the battery electric vehicle 100 as parameters. For example, the map M10 provides the first target drive force TF1 with the accelerator operation amount of the accelerator pedal 22 and the rotation speed of the electric motor 2 as parameters. Further, the map M10 may be configured to provide the first target drive force TF1 with the brake operation amount of the brake pedal 24 or the SOC of the battery 14 as a parameter.

The first target drive force calculation unit 120 transmits the calculated first target drive force TF1 to the mediation unit 140. The processing related to the first target drive force calculation unit 120 in the present embodiment may be appropriately changed. The processing related to the first target drive force calculation unit 120 can employ a known suitable method used to calculate the target drive force in a normal BEV in the related art.

The second target drive force calculation unit 130 acquires the information on the target virtual vehicle from the mode information acquisition unit 110. The second target drive force calculation unit 130 calculates a second target drive force TF2 that is the target drive force for realizing the simulated acceleration characteristic VC of the target virtual vehicle, based on the signal from the sensor system 50. The second target drive force TF2 can also be the target drive force for driving the battery electric vehicle 100 in the on-demand mode. Details of the processing executed by the second target drive force calculation unit 130 will be described below. The second target drive force calculation unit 130 transmits the calculated second target drive force TF2 to the mediation unit 140.

The mediation unit 140 mediates the target drive force TF used for controlling the electric motor 2 according to the selected control mode. Specifically, while the normal mode is selected, the mediation unit 140 transmits the first target drive force TF1 as the target drive force TF to the electric motor controller 150. In addition, while the on-demand mode is selected, the mediation unit 140 transmits the second target drive force TF2 as the target drive force TF to the electric motor controller 150. On the other hand, while the proficiency mode is selected, the mediation unit 140 executes proficiency mode calculation processing P10. In the proficiency mode calculation processing P10, the mediation unit 140 executes proficiency determination processing P11 based on the signal from the sensor system 50 to determine the proficiency of the driver. In addition, in the proficiency mode calculation processing P10, the mediation unit 140 calculates a third target drive force that changes from the first target drive force TF1 to a second target drive force TF2 as the proficiency of the driver increases. Details of the proficiency mode calculation processing P10 and the proficiency determination processing P11 executed by the mediation unit 140 will be described below. While the proficiency mode is selected, the mediation unit 140 transmits the third target drive force as the target drive force TF to the electric motor controller 150.

The electric motor controller 150 controls the electric motor 2 to realize the target drive force TF transmitted from the mediation unit 140. More specifically, the electric motor controller 150 generates a control signal for the inverter 16 in response to the target drive force TF. The electric motor controller 150 changes the motor torque output by the electric motor 2 via the PWM control by the inverter 16.

In this way, the drive control device 101a according to the present embodiment calculates the target drive force TF of the battery electric vehicle 100 according to the control mode. The drive control device 101a according to the present embodiment controls the output of the electric motor 2 such that the calculated target drive force TF is realized. In particular, with the drive control device 101a, the acceleration characteristic of the battery electric vehicle 100 while the normal mode is selected becomes the standard acceleration characteristic DC. In addition, the acceleration characteristic of the battery electric vehicle 100 while the on-demand mode is selected becomes the simulated acceleration characteristic VC of the target virtual vehicle. The simulated acceleration characteristic VC changes to various patterns according to the target virtual vehicle as the target virtual vehicle is changed. As a result, in the on-demand mode, the driver can enjoy the acceleration characteristics of various virtual vehicles in the battery electric vehicle 100. Further, with the drive control device 101a, the acceleration characteristic of the battery electric vehicle 100 while the proficiency mode is selected changes from the simulated acceleration characteristic VC to the standard acceleration characteristic DC according to the proficiency of the driver. As a result, in the proficiency mode, the driver can gradually become accustomed to driving in the normal mode.

The drive control device 101a may be configured not to execute the processing related to the first target drive force calculation unit 120 while the on-demand mode is selected. Similarly, the drive control device 101a may be configured not to execute the processing related to the second target drive force calculation unit 130 while the normal mode is selected. With the configuration as described above, it is possible to reduce the processing cost of the drive control device 101a in each of the control modes.

Hereinafter, the processing executed by the second target drive force calculation unit 130 and the proficiency mode calculation processing P10 executed by the mediation unit 140 will be described in detail.

### 4.1. Second Target Drive Force Calculation Unit

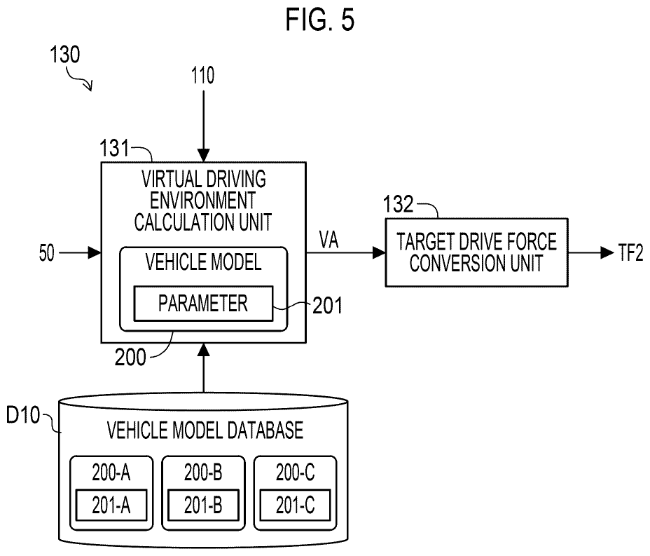

FIG. 5 is a diagram showing an example of a functional configuration of the second target drive force calculation unit 130. The second target drive force calculation unit 130 calculates the second target drive force TF2. The second target drive force calculation unit 130 includes a virtual driving environment calculation unit 131 and a target drive force conversion unit 132 as functional blocks. In addition, the second target drive force calculation unit 130 is configured to be accessible to a vehicle model database D10.

The vehicle model database D10 manages a plurality of vehicle models 200 obtained by modeling the plurality of virtual vehicles. The vehicle model database D10 may be stored in the storage device 103 as data 105. In addition, each of the vehicle models 200 managed by the vehicle model database D10 may be updated at any time. Further, a new vehicle model 200 may be downloaded in the vehicle model database D10 at any time. In the example shown in FIG. 5, the vehicle model database D10 manages three vehicle models 200-A, 200-B, and 200-C. Each of the vehicle models 200 is a model that simulates a driving environment of a virtual vehicle for a driving operation of a driver with an operation state of a driving operation member and a traveling state of the battery electric vehicle 100 as inputs. In particular, each of the vehicle models 200 is configured to enable the simulation of the acceleration characteristics of the virtual vehicle. That is, each of the vehicle models 200 is configured to be able to simulate at least the drive force given to the virtual vehicle in response to the driving operation of the driver and the acceleration and deceleration operation of the virtual vehicle due to the action of the drive force. The simulation result of the acceleration and deceleration operation of the virtual vehicle by each of the vehicle models 200 includes virtual acceleration VA of the virtual vehicle.

Typically, each of the vehicle models 200 includes a control model that simulates a control system related to the powertrain of the virtual vehicle and a plant model that simulates the acceleration and deceleration operation of the virtual vehicle in response to a control signal from the control model. In this case, the plant model includes a model of the powertrain that operates based on the control signal from the control model and a model for simulating the operation of the virtual vehicle due to the action of the virtual drive force of the powertrain model. An example of a configuration of the vehicle model 200 will be described below.

Further, each of the vehicle models 200 has a parameter 201 related to the operation of the virtual vehicle in the simulation. Examples of the parameter 201 include weight, wheel diameter, gear ratio, maximum torque of the drive source, drive torque responsiveness, and a shift schedule. The content of the parameter 201 may be different for each vehicle model 200. The vehicle model 200 expresses a model of one virtual vehicle by a combination with a setting value of the parameter 201 thereof. For example, each of the virtual vehicles represents a model of one virtual vehicle by a combination of the vehicle model 200 and the setting value of the parameter 201 as shown in the table below. As shown in the table below, the same vehicle model 200 may correspond to different virtual vehicles.

This is a case where types of powertrain systems thereof are the same as each other and the respective virtual vehicles can be expressed by changes in the setting value of the parameter 201, or the like.

TABLE 1

| Virtual vehicle | Vehicle model | Parameter |
|---|---|---|
| Virtual vehicle A1 | 200-A | Setting value A1 |
| Virtual vehicle A2 | 200-A | Setting value A2 |
| Virtual vehicle B1 | 200-B | Setting value B1 |
| Virtual vehicle C1 | 200-C | Setting value C1 |
| Virtual vehicle C2 | 200-C | Setting value C2 |

The virtual driving environment calculation unit 131 acquires the information on the target virtual vehicle from the mode information acquisition unit 110. The virtual driving environment calculation unit 131 reads out the vehicle model 200 (target vehicle model) corresponding to the target virtual vehicle from the acquired information with reference to the vehicle model database D10. Further, the virtual driving environment calculation unit 131 sets the parameters 201 of the read vehicle model 200 according to the target virtual vehicle. For example, when the target virtual vehicle is the “Virtual vehicle B1” in the table above, the virtual driving environment calculation unit 131 reads a vehicle model 200-B by referring to the vehicle model database D10. The virtual driving environment calculation unit 131 sets a parameter 201-B of the vehicle model 200-B to a setting value B1.

The virtual driving environment calculation unit 131 uses the read target vehicle model to simulate the virtual driving environment of the target virtual vehicle for the driving operation of the driver. More specifically, the virtual driving environment calculation unit 131 receives a signal from the sensor system 50, and acquires information on an operation state of a driving operation member and information on a traveling state of the battery electric vehicle 100 for use as inputs to the target vehicle model. For example, the virtual driving environment calculation unit 131 acquires the accelerator operation amount of the accelerator pedal 22 and the vehicle speed of the battery electric vehicle 100. In addition, depending on the configuration of the target vehicle model, the virtual driving environment calculation unit 131 may acquire the accelerator operation speed of the accelerator pedal 22, the brake operation amount and the brake operation speed of the brake pedal 24. Further, the virtual driving environment calculation unit 131 may acquire information such as a steering angle of the steering wheel and the yaw rate of the battery electric vehicle 100. The virtual driving environment calculation unit 131 simulates the virtual driving environment of the target virtual vehicle by inputting the acquired information to the target vehicle model. In particular, the virtual driving environment calculation unit 131 calculates the virtual acceleration VA of the target virtual vehicle with respect to the driving operation of the driver through the simulation of the virtual driving environment of the target virtual vehicle. The virtual driving environment calculation unit 131 transmits the calculated virtual acceleration VA to the target drive force conversion unit 132.

When the virtual acceleration VA is acquired, the target drive force conversion unit 132 converts the drive force for setting the acceleration of the battery electric vehicle 100 to the virtual acceleration VA, and sets the drive force as the second target drive force TF2. For example, the target drive force conversion unit 132 converts the virtual acceleration VA into the second target drive force TF2 by using a simplified inverse model of the battery electric vehicle 100 as shown in the following equation. In the following equation, m is the vehicle weight of the battery electric vehicle 100, and F_{load} is actual traveling resistance of the battery electric vehicle 100. The second target drive force calculation unit 130 outputs the second target drive force TF2 calculated by the target drive force conversion unit 132.

$$TF 2 = m \times VA - {F}_{load} \qquad Formula 1$$

As described above, the second target drive force calculation unit 130 calculates the virtual acceleration VA of the target virtual vehicle in response to the driving operation of the driver by simulating the driving environment of the target virtual vehicle by using the target vehicle model. The second target drive force calculation unit 130 calculates the second target drive force TF2 such that the acceleration of the battery electric vehicle 100 is the calculated virtual acceleration VA.

### 4.2. Proficiency Mode Calculation Processing

Hereinafter, the proficiency mode calculation processing P10 executed by the mediation unit 140 will be described. As described above, in the proficiency mode calculation processing P10, the mediation unit 140 executes the proficiency determination processing P11 to determine the proficiency of the driver. First, the determination of the proficiency of the driver by the proficiency determination processing P11 will be described.

The proficiency of the driver is determined, for example, between 0% and 100%. In this case, the proficiency at the time at which the proficiency mode is initiated may be 0%. One viewpoint for determining the proficiency of the driver is the driving time or the traveling distance from the time when the proficiency mode is initiated. It is considered that the driver becomes accustomed to driving the vehicle as the driving time or the traveling distance for one vehicle becomes longer. Therefore, in the proficiency determination processing P11, the mediation unit 140 increases the proficiency in proportion to the driving time or the traveling distance from the time when the proficiency mode is initiated. For example, the mediation unit 140 gradually increases the proficiency by the proportional coefficient each time the driving time or the traveling distance from the time when the proficiency mode is initiated is increased by the setting value. That is, when the proficiency is P and the proportional coefficient is Ax, the mediation unit 140 sets P=P+Δx each time the driving time or the traveling distance is increased by the setting value. The setting value is set to, for example, a standard value taken until the driver becomes accustomed to driving. The setting value and the proportional coefficient may be experimentally suitably determined according to the environment to which the present embodiment is applied.

On the other hand, the driving time or the traveling distance until the driver becomes accustomed to driving may be different depending on the individual characteristics of the driver or the characteristics of the road on which the vehicle travels. Therefore, when the proficiency is increased in proportion to the driving time or the traveling distance, there is a possibility that the proficiency is increased in a state where the driver does not sufficiently become accustomed to driving. Therefore, in the proficiency determination processing P11, the mediation unit 140 may further monitor the driving operation of the driver. The mediation unit 140 may decrease the proficiency when a condition (hereinafter, referred to as “insufficient proficiency condition”) indicating that the driving operation is not yet accustomed to the driving is satisfied. That is, the mediation unit 140 sets P=P−Δy when the driving operation satisfies the insufficient proficiency condition. Δy represents an amount of decrease in the proficiency.

One of the insufficient proficiency conditions is a condition related to the accelerator operation of the driver at the time of start. When the driver is not sufficiently accustomed to driving, a driving operation in which the depressing of the accelerator pedal 22 at the time of start is not smooth is often observed. For example, when the vehicle that the driver has previously boarded is a vehicle that responds slowly to the accelerator operation amount at the time of start, the driver may depress the accelerator pedal 22 more strongly than needed. Further, after that, the driver is considered to perform the driving operation of weakly depressing the accelerator pedal 22 to gradually increase the vehicle speed after releasing the accelerator pedal 22.

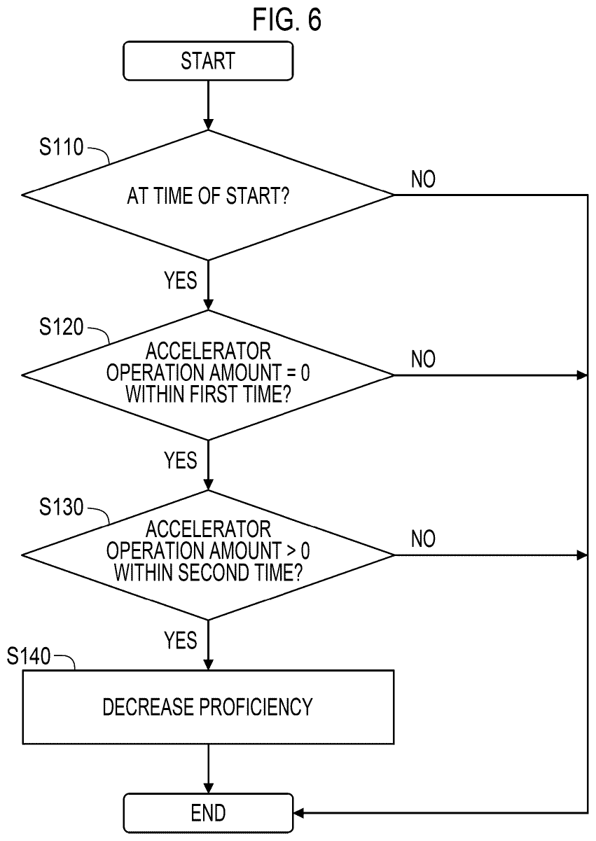

FIG. 6 is a flowchart showing a processing flow of the proficiency determination processing P11 for the insufficient proficiency condition regarding the accelerator operation of the driver at the time of the start described above.

In S110, the mediation unit 140 determines whether the battery electric vehicle 100 is at the time of start. For example, the mediation unit 140 determines that the battery electric vehicle 100 is at the time of start when the immediately preceding vehicle speed is zero and the current accelerator operation amount is larger than zero. When the battery electric vehicle 100 is not at the time of start (S110; No), the processing ends without decreasing the proficiency. When the battery electric vehicle 100 is at the time of start (S110; Yes), the processing proceeds to S120.

In S120, the mediation unit 140 determines whether the accelerator operation amount becomes zero within the first time. That is, it is determined whether the driver has released the accelerator pedal 22. The first time may be experimentally appropriately determined. When the accelerator operation amount is not zero within the first time (S120; No), the processing ends without decreasing the proficiency. When the accelerator operation amount becomes zero within the first time (S120; Yes), the processing proceeds to S130.

In S130, the mediation unit 140 determines whether the accelerator operation amount becomes larger than zero within the second time after the accelerator operation amount becomes zero. That is, the determination is made whether the driver depresses the accelerator pedal 22 again. The second time may be experimentally suitably determined. When the accelerator operation amount is not greater than zero within the second time (S130; No), the processing ends without decreasing the proficiency. When the accelerator operation amount becomes larger than zero within the second time (S130; Yes), the mediation unit 140 decreases the proficiency (S140).

As described above, in the proficiency determination processing P11, the mediation unit 140 may be configured to decrease the proficiency when the driving operation satisfies the insufficient proficiency condition. The insufficient proficiency condition may include a plurality of conditions. For example, the insufficient proficiency condition may include a condition regarding the accelerator operation of the driver during acceleration or deceleration. The mediation unit 140 may be configured to execute processing for each insufficient proficiency condition. In particular, the amount Ay of decrease in the proficiency may be set to different values for each of the insufficient proficiency conditions. Further, when the driving operation satisfies the insufficient proficiency condition, the mediation unit 140 may decrease the proportional coefficient Δx when increasing the proficiency. In addition, the mediation unit 140 may increase the proportional coefficient Δx each time a predetermined period elapses during which the insufficient proficiency condition is not satisfied.

Further, in the proficiency determination processing P11, the mediation unit 140 may be configured to increase or decrease the proficiency stepwise in response to the input operation from the driver. For example, the HMI 20 may include a switch for increasing or decreasing the proficiency.

As described above, the mediation unit 140 executes the proficiency determination processing P11 in the proficiency mode calculation processing P10 to determine the proficiency of the driver. Next, an entirety of the proficiency mode calculation processing P10 will be described.

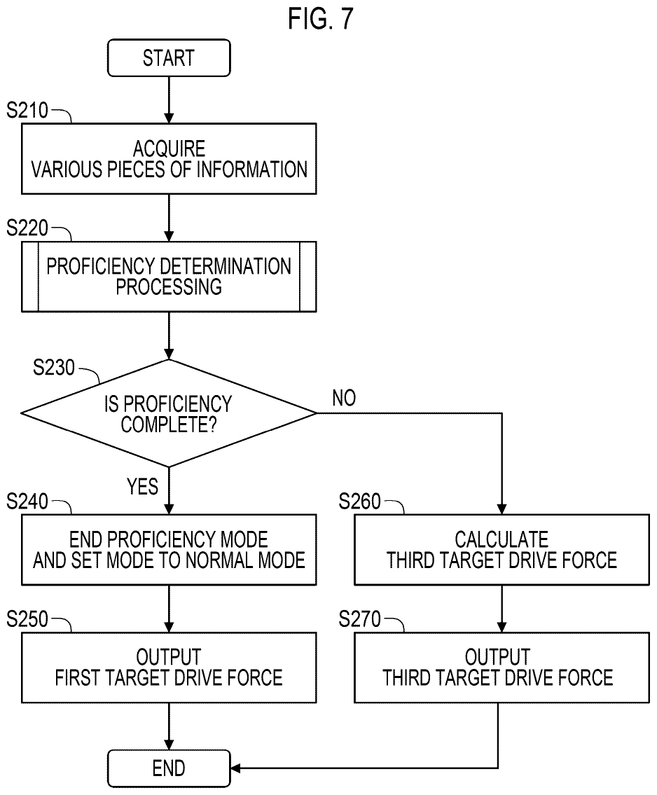

FIG. 7 is a flowchart showing a processing flow of the proficiency mode calculation processing P10 executed by the mediation unit 140. A processing flow shown in FIG. 7 is repeatedly executed for each predetermined processing cycle.

In S210, the mediation unit 140 acquires various pieces of information. For example, the mediation unit 140 acquires a vehicle speed, an accelerator operation amount, a driving time, a traveling distance, and the like.

Next, in S220, the mediation unit 140 executes the proficiency determination processing P11 to determine the proficiency of the driver. The content of the proficiency determination processing P11 is as described above.

Next, in S230, the mediation unit 140 determines whether the proficiency of the driver is complete in the proficiency mode. The mediation unit 140 determines that the proficiency of the driver is complete when the driving time or the traveling distance exceeds a predetermined value after the proficiency becomes the maximum (for example, 100%). The predetermined value may be experimentally appropriately determined. Even when the proficiency becomes the maximum, there is a possibility that the proficiency is decreased again thereafter. Therefore, by executing the processing as described above, it is possible to reliably determine the completion of the proficiency of the driver.

When the proficiency of the driver is complete (S230; Yes), the mediation unit 140 ends the proficiency mode and sets the mode to the normal mode (S240), and outputs the first target drive force TF1 as the target drive force TF (S250). When the proficiency of the driver is not complete (S230; No), the processing proceeds to S260.

In S260, the mediation unit 140 calculates a third target drive force that changes from the first target drive force TF1 to the second target drive force TF2 as the proficiency of the driver increases. For example, the mediation unit 140 calculates a third target drive force TF3 by the following equation. In the following equation, k_{P} is a coefficient that monotonically increases with respect to an increase in the proficiency and has a value of 0 to 1. For example, k_{P} linearly increases from 0 to 1 in proportion to the proficiency. Note that k_{P} may be configured to increase nonlinearly. After S260, the processing proceeds to S270.

$$TF 3 = ( 1 - {k}_{P} ) \times TF 1 \times + {k}_{P} \times TF 2 \qquad Formula 2$$

In S270, the mediation unit 140 outputs the third target drive force TF3 as the target drive force TF. Thereafter, this processing ends.

As described above, the mediation unit 140 executes the proficiency mode calculation processing P10. As a result, when the control mode is the proficiency mode, the acceleration characteristic of the battery electric vehicle 100 can be changed from the simulated acceleration characteristic VC to the standard acceleration characteristic DC according to the proficiency of the driver. As a result, in the proficiency mode, the driver can gradually become accustomed to driving in the normal mode.

### 4.3. Configuration Example of Vehicle Model

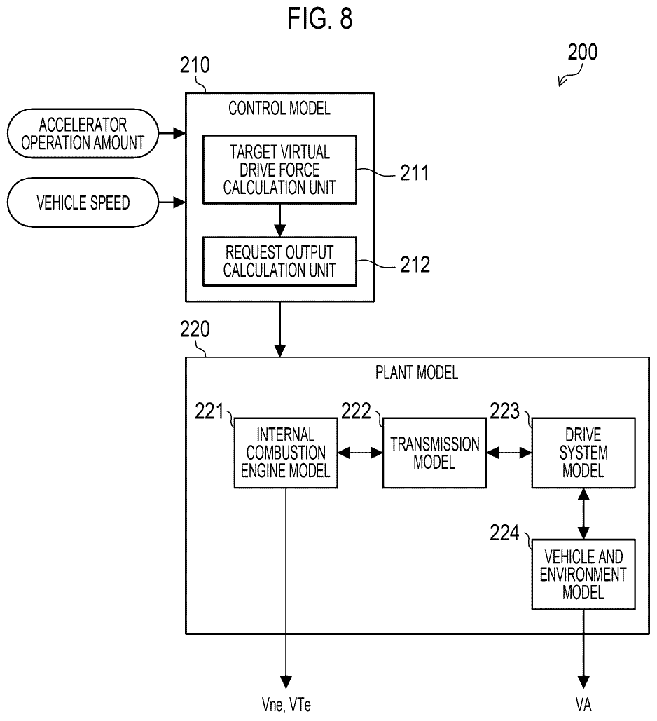

Hereinafter, an example of the configuration of the vehicle model 200 managed by the vehicle model database D10 will be described. FIG. 8 is a diagram showing an example of the configuration of the vehicle model 200. The vehicle model 200 includes a control model 210 and a plant model 220. The control model 210 simulates the control system related to the powertrain of the virtual vehicle. The plant model 220 simulates the acceleration and deceleration operation of the virtual vehicle in response to the control signal from the control model 210. The plant model 220 includes a model of the powertrain that operates based on the control signal from the control model 210 and a model for simulating the operation of the virtual vehicle due to the action of the virtual drive force of the powertrain model. The control model 210 may also simulate the control system that calculates a request output for the powertrain of the virtual vehicle. Further, the plant model 220 may also simulate a physical constraint on the request output for the powertrain.

The specifications of the control model 210 and the plant model 220 may be different for each type of the powertrain system. For example, configurations of the control system, a transmission, and a drive system are different between the CONV and the HEV. Thus, in each of the vehicle model 200 of the CONV and the vehicle model 200 of the HEV, both the control model 210 and the plant model 220 have different specifications. The example shown in FIG. 8 particularly shows a case where the virtual vehicle is an automatic transmission vehicle (AT vehicle) including the internal combustion engine.

The control model 210 includes a target virtual drive force calculation unit 211 and a request output calculation unit 212. The target virtual drive force calculation unit 211 calculates the virtual drive force (target virtual drive force) requested for the powertrain of the virtual vehicle, based on the accelerator operation amount and the vehicle speed. For example, the target virtual drive force calculation unit 211 performs the calculation using a map in which the target virtual drive force is provided for a combination of the accelerator operation amount and the vehicle speed. The request output calculation unit 212 calculates the request output for the powertrain such that the calculated target virtual drive force can be satisfied. The calculated request output includes a target engine torque of the internal combustion engine or a target gear stage of the transmission. The control model 210 transmits the calculated request output to the plant model 220.

The plant model 220 includes an internal combustion engine model 221, a transmission model 222, a drive system model 223, and a vehicle and environment model 224. The internal combustion engine model 221, the transmission model 222, and the drive system model 223 are models of the powertrain from the drive source to the drive wheels. The vehicle and environment model 224 is a model for simulating the operation of the virtual vehicle due to the action of the virtual drive force of the powertrain model.

The internal combustion engine model 221 is for the internal combustion engine of the virtual vehicle. The internal combustion engine model 221 simulates, for example, the operation of the internal combustion engine in response to an input of the target engine torque. The internal combustion engine model 221 outputs a virtual engine rotation speed VNe and a virtual engine torque VTe. The parameter 201 that may be changed according to the target virtual vehicle in the internal combustion engine model 221 is, for example, the maximum engine torque and the engine torque responsiveness.

The transmission model 222 is for the transmission of the virtual vehicle. The transmission model 222 simulates, for example, the operation of the transmission in response to an input of the target gear stage. The transmission model 222 outputs the virtual transmission output torque from the gear ratio determined by the virtual engine torque VTe and the virtual gear stage output by the internal combustion engine model 221. The transmission model 222 includes a stepped transmission model that simulates a stepped transmission and a continuously variable transmission model that simulates a continuously variable transmission. Any one of the stepped transmission model and the continuously variable transmission model is selected according to the target virtual vehicle. The parameters 201 that can be changed in the transmission model 222 according to the target virtual vehicle are, for example, the gear ratio and the shift schedule. In the case of the stepped transmission model, the gear ratio means the gear ratio of each of the gear stages.

The drive system model 223 is for the drive system of the virtual vehicle. In the drive system model 223, for example, a mechanical structure from the transmission to the drive wheels is modeled. The drive system model 223 calculates a drive wheel torque by using the virtual transmission output torque output by the transmission model 222 and a predetermined deceleration ratio, and outputs the virtual drive force of the virtual vehicle. The parameter 201 that may be changed according to the target virtual vehicle in the drive system model 223 is, for example, a deceleration ratio and a maximum allowable torque of a propeller shaft.

The vehicle and environment model 224 represents a dynamic characteristic of the virtual vehicle and a traveling environment of the virtual vehicle. The vehicle and environment model 224 calculates the traveling resistance applied to the virtual vehicle from the traveling environment of the virtual vehicle. The vehicle and environment model 224 simulates the acceleration and deceleration operation of the virtual vehicle from the virtual drive force output from the drive system model 223, the calculated traveling resistance, and the dynamic characteristics of the virtual vehicle. The vehicle and environment model 224 outputs the virtual acceleration VA from the acceleration and deceleration operation of the virtual vehicle. The parameter 201 that can be changed according to the target virtual vehicle in the vehicle and environment model 224 is, for example, a weight, a wheel diameter, and a CD value.

It is possible to configure the vehicle model 200 as described above. The vehicle model 200 shown in FIG. 8 is an example. It is also possible to configure a part of the vehicle model 200 in more detail according to an event to be emphasized. For example, a case is considered in which a shock or a response accompanying shifts in a gear and a clutch of a transmission at a time of kick down is to be emphasized. In this case, the transmission model 222 may be configured to finely reproduce a gear mechanism, such as planetary and Ravigneaux, of the transmission, inertia of each component, a change in a transmission path due to engagement and disengagement of the clutch, and the like. On the other hand, when a calculation load in the vehicle model 200 is desired to be reduced, the transmission model 222 may be simply configured to reproduce only the gear ratio.

### 5. In-Vehicle Apparatus Control Device

The control device 101 according to the present embodiment functions as an in-vehicle apparatus control device that controls the speaker 11 and the instrument 13. Specifically, the processor 102 functions as the in-vehicle apparatus control device by executing the computer program 104 for in-vehicle apparatus control stored in the storage device 103. In particular, the in-vehicle apparatus control device controls the speaker 11 or the instrument 13 according to the driving environment of the target virtual vehicle when the battery electric vehicle 100 is in the on-demand mode. Hereinafter, the control of the battery electric vehicle 100 by the in-vehicle apparatus control device when the battery electric vehicle 100 is in the on-demand mode will be described.

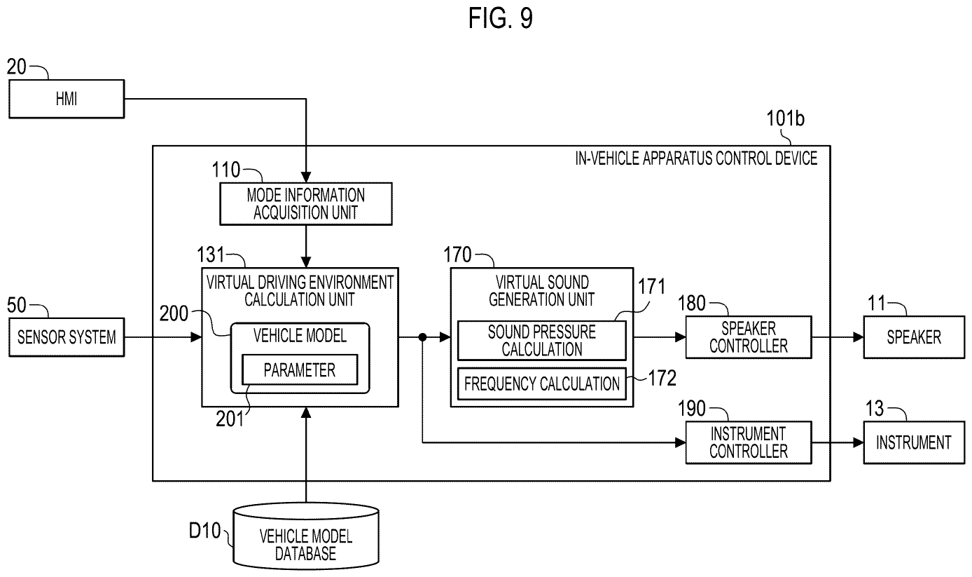

FIG. 9 is a diagram showing an example of a functional configuration of the in-vehicle apparatus control device 101b. The in-vehicle apparatus control device 101b controls the speaker 11 or the instrument 13 according to the driving environment of the target virtual vehicle when the battery electric vehicle 100 is in the on-demand mode.

The signals from the HMI 20 and the sensor system 50 are input to the in-vehicle apparatus control device 101b. The signal input from the HMI 20 to the in-vehicle apparatus control device 101b includes a signal indicating the control mode selected by the driver and a signal indicating the target virtual vehicle selected by the driver. The signals input from the sensor system 50 to the in-vehicle apparatus control device 101b include a signal indicating the vehicle speed of the battery electric vehicle 100 and a signal indicating the operation state of the accelerator pedal 22. Further, the signals input from the sensor system 50 to the in-vehicle apparatus control device 101b include a signal indicating an operation state of the brake pedal 24, a signal indicating a rotation speed of the electric motor 2, and a signal indicating a state of charge (SOC) of the battery 14.

The in-vehicle apparatus control device 101b includes a mode information acquisition unit 110, a virtual driving environment calculation unit 131, a virtual sound generation unit 170, a speaker controller 180, and an instrument controller 190 as functional blocks. These functional blocks are realized by the cooperation of the processor 102 that executes the computer program 104 and the storage device 103. The mode information acquisition unit 110 may be the same as that described in FIG. 4. The virtual driving environment calculation unit 131 may be the same as that described in FIG. 5.

The virtual sound generation unit 170 generates the virtual sound that should be heard by the driver in the target virtual vehicle in response to the driving operation of the driver. The virtual sound is, for example, an engine sound (pseudo engine sound) generated by an internal combustion engine of the target virtual vehicle when the target virtual vehicle is a vehicle (engine vehicle) including an internal combustion engine. In addition, for example, the virtual sound is a sound of a drive system of the target virtual vehicle. The virtual sound generation unit 170 acquires a sound source of the virtual sound related to the target virtual vehicle with reference to the storage device 103. The storage device 103 may store a sound source of the virtual sound for each of the virtual vehicles. In addition, the virtual sound generation unit 170 acquires information needed to generate the virtual sound from the virtual driving environment calculation unit 131. For example, when the virtual sound is the pseudo engine sound, the virtual sound generation unit 170 acquires the virtual engine rotation speed VNe and the virtual engine torque VTe from the virtual driving environment calculation unit 131. The virtual sound generation unit 170 generates the virtual sound based on the information acquired from the sound source and the virtual driving environment calculation unit 131.

The virtual sound generation unit 170 executes processing 171 of calculating the sound pressure of the virtual sound and processing 172 of calculating the frequency of the virtual sound. For example, when the virtual sound is the pseudo engine sound, in the processing 171, the sound pressure of the pseudo engine sound is calculated from the virtual engine torque VTe using the sound pressure map. The sound pressure map is typically created such that the larger the virtual engine torque VTe is, the larger the sound pressure is. In addition, in the processing 172, the frequency of the virtual sound is calculated from the virtual engine rotation speed VNe using the frequency map. The frequency map is typically created such that the higher the virtual engine rotation speed VNe is, the higher the frequency is. The virtual sound generation unit 170 transmits the generated sound data of the virtual sound to the speaker controller 180.

The speaker controller 180 controls the output of the speaker 11 based on the sound data transmitted from the virtual sound generation unit 170. As a result, the virtual sound is output from the speaker 11.

The instrument controller 190 controls the instrument 13 to display information (hereinafter, referred to as “virtual display information”) to be displayed to the driver in the target virtual vehicle in response to the driving operation of the driver. The virtual display information is, for example, the virtual engine rotation speed VNe or virtual gear stage information of the target virtual vehicle when the target virtual vehicle is an engine vehicle. The instrument controller 190 acquires the information related to the virtual display information from the virtual driving environment calculation unit 131. For example, when the target virtual vehicle is the engine vehicle, the instrument controller 190 acquires the virtual engine rotation speed VNe and the virtual gear stage from the virtual driving environment calculation unit 131. The instrument controller 190 controls the display of the instrument 13 based on the acquired information. As a result, the virtual display information is displayed on the instrument 13.

As described above, with the in-vehicle apparatus control device 101b, in a case where the battery electric vehicle 100 is in the on-demand mode, the virtual sound is output from the speaker 11, and the virtual display information is displayed on the instrument 13. Accordingly, it is possible to further provide the driver with the sense of reality as if the driver drives the target virtual vehicle.

### 6. Others

The technical features according to the present embodiment can be widely applied to a battery electric vehicle having an electric motor as a drive source, not limited to a BEV. For example, the technical features according to the present embodiment can be applied to an HEV or a PHEV having a mode of traveling solely by a drive force of an electric motor. In addition, the technical features can also be applied to an FCEV that supplies electric energy generated by a fuel cell to an electric motor.

What is claimed is:

1. A battery electric vehicle including an electric motor as a drive source, the battery electric vehicle comprising one or more processors configured to control an output of the electric motor, wherein the one or more processors are configured to, when the battery electric vehicle is in a proficiency mode,
acquire information on a target virtual vehicle selected from among a plurality of virtual vehicles,
control the output of the electric motor such that an acceleration characteristic of the battery electric vehicle with respect to a driving operation of a driver becomes a simulated acceleration characteristic of the target virtual vehicle when the proficiency mode is initiated, and
control the output of the electric motor such that the acceleration characteristic of the battery electric vehicle with respect to the driving operation of the driver is close to a standard acceleration characteristic, as proficiency of the driver increases.

2. The battery electric vehicle according to claim 1, further comprising:
a driving operation member used for driving; and
one or more storage devices configured to manage a plurality of vehicle models that models the virtual vehicles, wherein the one or more processors are configured to, when the battery electric vehicle is in the proficiency mode,
acquire, from the one or more storage devices, a target vehicle model corresponding to the target virtual vehicle,
calculate a first target drive force with which the standard acceleration characteristic is realized,
calculate, based on an operation state of the driving operation member and a traveling state of the battery electric vehicle, using the target vehicle model, a second target drive force with which the simulated acceleration characteristic is realized,
calculate a third target drive force that changes from the first target drive force to the second target drive force as the proficiency increases, and
control the output of the electric motor to provide the battery electric vehicle with the third target drive force.

3. The battery electric vehicle according to claim 1, wherein the one or more processors are configured to end the proficiency mode when a driving time or a traveling distance exceeds a predetermined value after the proficiency has been maximized.

4. The battery electric vehicle according to claim 1, wherein the one or more processors are configured to, when the battery electric vehicle is in the proficiency mode, increase the proficiency in proportion to a driving time or a traveling distance from a point at which the proficiency mode is initiated.

5. The battery electric vehicle according to claim 4, wherein the one or more processors are configured to, when the battery electric vehicle is in the proficiency mode, decrease the proficiency when a condition that the driving operation of the driver indicates the driver is not accustomed to driving is satisfied.
